(19) United States
(12) Patent Application Publication
(10) Pub. No.: US 2022/0128840 A1
(43) Pub. Date: Apr. 28, 2022

(54) Costume Eyeglass Assembly

(71) Applicant: Michael Peterson, North Highlands, CA (US)

(72) Inventor: Michael Peterson, North Highlands, CA (US)

(21) Appl. No.: 17/081,343

(22) Filed: Oct. 27, 2020

(51) Int. Cl. G02C 11/02; G02C 11/00

(52) U.S. Cl. CPC G02C 11/02; G02C 11/10

(57) ABSTRACT

A costume eyeglasses assembly for presenting the appearance of monster eyes includes a pair of eyeglasses that can be worn on a user's head. The pair of eyeglasses includes a frame and a pair of lenses, and the frame includes a pair of arms. A pair of panels is each coupled to the pair of eyeglasses and each of the panels is positioned behind a respective one of the lenses. Each of the panels is offset from a center of the respective lens such that the panels do not inhibit the user's vision. A pair of light emitters is each of the light emitters is coupled to a respective one of the panels to emit light outwardly therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to eyeglasses devices and more particularly pertains to a new eyeglasses device for presenting the appearance of monster eyes.

### (2) Description of Related Art Including Information Disclosed Under 37 CFR 1.97 and 1.98

The prior art relates to eyeglasses devices including a variety of eyeglasses that each has a plurality of light emitters being integrated into a frame of the eyeglasses. The prior art discloses a pair of eyeglasses that has a pair of light emitters being positioned in front of respective lenses for presenting the appearance of monster eyes.

### BRIEF SUMMARY OF THE INVENTION

An embodiment of the disclosure meets the needs presented above by generally comprising a pair of eyeglasses that can be worn on a user's head. The pair of eyeglasses includes a frame and a pair of lenses, and the frame includes a pair of arms. A pair of panels is each coupled to the pair of eyeglasses and each of the panels is positioned behind a respective one of the lenses. Each of the panels is offset from a center of the respective lens such that the panels do not inhibit the user's vision. A pair of light emitters is each of the light emitters is coupled to a respective one of the panels to emit light outwardly therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a costume eyeglasses assembly according to an embodiment of the disclosure.

FIG. 2 is a perspective in-use view of an embodiment of the disclosure.

FIG. 3 is a back view of an embodiment of the disclosure.

FIG. 4 is a top view of an embodiment of the disclosure.

FIG. 5 is a cross sectional view taken along line 5-5 of FIG. 4 of an embodiment of the disclosure.

### DETAILED DESCRIPTION OF THE INVENTION

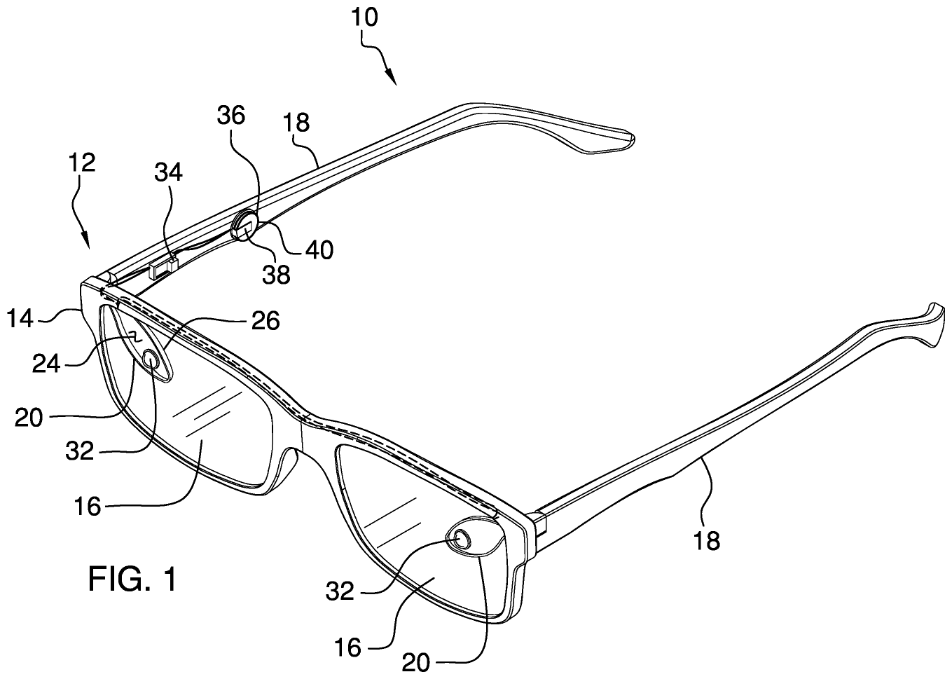

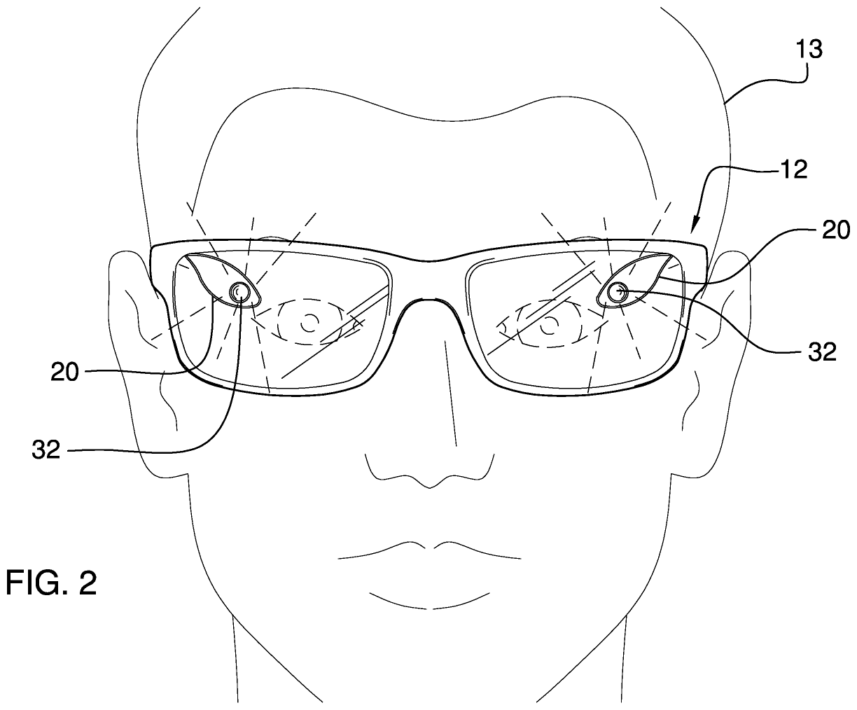

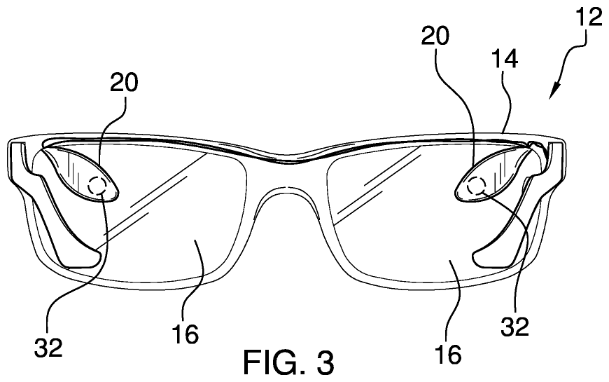

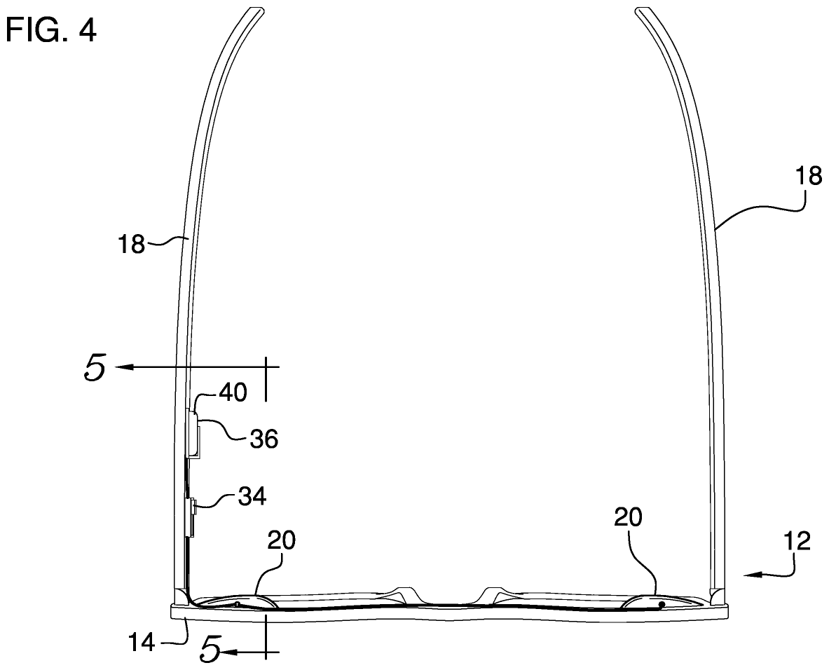

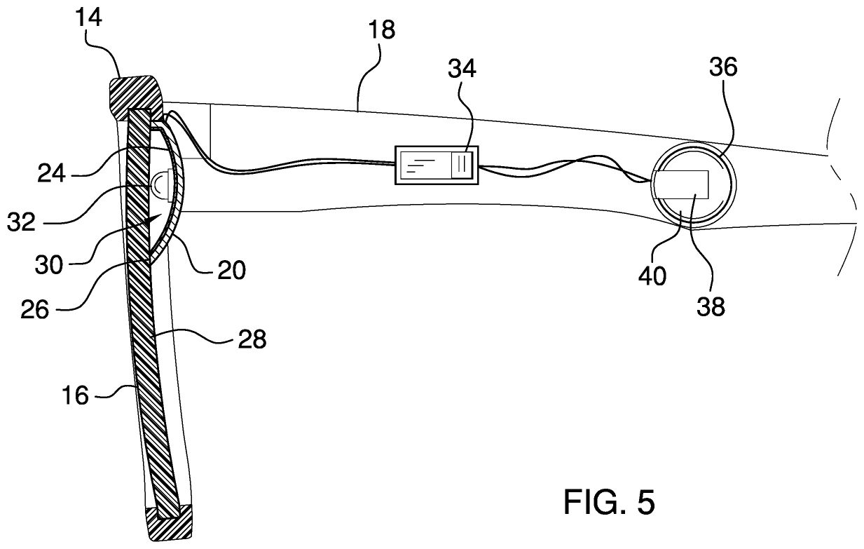

With reference now to the drawings, and in particular to FIGS. 1 through 5 thereof, a new eyeglasses device embodying the principles and concepts of an embodiment of the disclosure and generally designated by the reference numeral 10 will be described.

As best illustrated in FIGS. 1 through 5, the costume eyeglasses assembly 10 generally comprises a pair of eyeglasses 12 that can be worn on a user's head 13. The pair of eyeglasses 12 includes a frame 14 and a pair of lenses 16, and the frame 14 includes a pair of arms 18. A pair of panels 20 is provided and each of the panels 20 is coupled to the pair of eyeglasses 12. Each of the panels 20 is positioned behind a respective one of the lenses 16. Each of the panels 20 is offset from a center of the respective lens 16 thereby facilitating each panel 20 to be offset from a user's line of vision. In this way panels 20 do not inhibit the user's vision.

Each of the panels 20 is comprised of a translucent material pass light therethrough. Each of the panels 20 has a forward surface 24 and a perimeter edge 26, and the perimeter edge 26 curves outwardly from a center point of the panel 20 and tapering to a point on opposite ends of the panel 20. In this way each of the panels 20 has an almond shape to simulate the ornamental appearance of a human eye. The forward surface 24 of each of the panels 20 faces a back side 28 of the respective lens 16. Each of the panels 20 is positioned in an upper outward quadrant of the respective lens 16 having each of the panels 20 being directed toward a center of the respective lens 16. The forward surface 24 of each of the panels 20 is concavely arcuate with respect to the back side 28 of the respective lens 16 to define a light space 30 between the forward surface 24 of each of the panels 20 and the back side 28 of the respective lens 16.

A pair of light emitters 32 is provided and each of the light emitters 32 is coupled to a respective one of the panels 20 to emit light outwardly therefrom. Each of the light emitters 32 is positioned on the forward surface 24 of the respective panel 20 such that each of the light emitters 32 is positioned in the light space 30 defined by the respective panel 20. Additionally, each of the light emitters 32 may comprise an LED or other type of electronic light emitter.

A switch 34 is slidably coupled to the eyeglasses 12 and the switch 34 is positioned on a respective one of the arms 18. The switch 34 is electrically coupled to each of the light emitters 32 for turning the light emitters 32 on and off. A power supply 36 is removably coupled to the eyeglasses 12 and the power supply 36 is electrically coupled to the switch 34. The power supply 36 comprises a set of contacts 38 and each of the contacts 38 is integrated into the respective arm 18. Each of the contacts 38 is electrically coupled to the switch 34 and each of the contacts 38 is comprised of an electrically conductive material. The power supply includes at least one battery 40 that is removably positioned between the set of contacts 38 to mount the at least one battery 40 to the eyeglasses 12. The at least one battery 40 is in electrical communication with the switch 34 when the at least one battery 40 is positioned in the set of contacts 38.

In use, the eyeglasses 12 are worn for the purposes of costuming or ornamental purposes. The switch 34 is manipulated to turn on each of the light emitters 32. Thus, the light emitters 32 emit light to simulate the appearance of a menacing creature. Additionally, each of the panels 20 is illuminated by the light emitters 32 when the light emitters 32 are turned on. In this way the ornamental appearance of the menacing creature is enhanced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A costume eyeglasses assembly for producing the illusion of illuminated eyes, said assembly comprising:
a pair of eyeglasses being configured to be worn on a user's head, said pair of eyeglasses including a frame and a pair of lenses, said frame including a pair of arms;
a pair of panels, each of said panels being coupled to said pair of eyeglasses, each of said panels being positioned behind a respective one of said lenses, each of said panels being offset from a center of said respective lens wherein each of said panels is configured to be offset from a user's line of vision such that said panels do not inhibit the user's vision, each of said panels being comprised of a translucent material wherein each of said panels is configured to pass light therethrough; and
a pair of light emitters, each of said light emitters being coupled to a respective one of said panels wherein each of said light emitters is configured to emit light outwardly therefrom.

2. The assembly according to claim 1, wherein each of said panels has a forward surface and a perimeter edge, said perimeter edge curving outwardly from a center point of said panel and tapering to a point on opposite ends of said panel such that each of said panels has an almond shape wherein each of said panels is configured to simulate the ornamental appearance of a human eye.

3. The assembly according to claim 2, wherein said forward surface of each of said panels faces a back side of said respective lens.

4. The assembly according to claim 2, wherein each of said panels is positioned in an upper outward quadrant of said respective lens having each of said panels being directed toward a center of said respective lens.

5. The assembly according to claim 3, wherein said forward surface of each of said panels being concavely arcuate with respect to said back side of said respective lens to define a light space between said forward surface of each of said panels and said back side of said respective lens.

6. The assembly according to claim 1, further comprising a switch being slidably coupled to said eyeglasses wherein said switch is configured to be manipulated by a user, said switch being positioned on a respective one of said arms, said switch being electrically coupled to each of said light emitters for turning said light emitters on and off.

7. The assembly according to claim 6, further comprising a power supply being removably coupled to said eyeglasses, said power supply being electrically coupled to said switch, said power supply comprising:
a set of contacts, each of said contacts being integrated into said respective arm, each of said contacts being electrically coupled to said switch, each of said contacts being comprised of an electrically conductive material; and
at least one battery being removably positioned between said set of contacts to mount said at least one battery to said eyeglasses, said at least one battery being in electrical communication with said switch when said at least one battery is positioned in said set of contacts.

8. A costume eyeglasses assembly for producing the illusion of illuminated eyes, said assembly comprising:
a pair of eyeglasses being configured to be worn on a user's head, said pair of eyeglasses including a frame and a pair of lenses, said frame including a pair of arms;
a pair of panels, each of said panels being coupled to said pair of eyeglasses, each of said panels being positioned behind a respective one of said lenses, each of said panels being offset from a center of said respective lens wherein each of said panels is configured to be offset from a user's line of vision such that said panels do not inhibit the user's vision, each of said panels being comprised of a translucent material wherein each of said panels is configured to pass light therethrough, each of said panels having a forward surface and a perimeter edge, said perimeter edge curving outwardly from a center point of said panel and tapering to a point on opposite ends of said panel such that each of said panels has an almond shape wherein each of said panels is configured to simulate the ornamental appearance of a human eye, said forward surface of each of said panels facing a back side of said respective lens, each of said panels being positioned in an upper outward quadrant of said respective lens having each of said panels being directed toward a center of said respective lens, said forward surface of each of said panels being concavely arcuate with respect to said back side of said respective lens to define a light space between said forward surface of each of said panels and said back side of said respective lens;
a pair of light emitters, each of said light emitters being coupled to a respective one of said panels wherein each of said light emitters is configured to emit light outwardly therefrom, each of said light emitters being positioned on said forward side of said respective panel such that each of said light emitters is positioned in said light space defined by said respective panel;
a switch being slidably coupled to said eyeglasses wherein said switch is configured to be manipulated by a user, said switch being positioned on a respective one of said arms, said switch being electrically coupled to each of said light emitters for turning said light emitters on and off; and
a power supply being removably coupled to said eyeglasses, said power supply being electrically coupled to said switch, said power supply comprising:
a set of contacts, each of said contacts being integrated into said respective arm, each of said contacts being electrically coupled to said switch, each of said contacts being comprised of an electrically conductive material; and
at least one battery being removably positioned between said set of contacts to mount said at least one battery to said eyeglasses, said at least one battery being in electrical communication with said switch when said at least one battery is positioned in said set of contacts.
